(19) United States
(12) Patent Application Publication
(10) Pub. No.: US 2009/0073182 A1
(43) Pub. Date: Mar. 19, 2009

(54) Two Dimensional Representation Of Color Spaces

(75) Inventor: Massimo Ballerini, Milano (IT)

Correspondence Address: FISH & RICHARDSON, PC, P.O. BOX 1022, MINNEAPOLIS, MN, 55440-1022, US

(73) Assignee: RGB LIGHT LIMITED, Tortola (IT)

(21) Appl. No.: 12/209,158

(22) Filed: Sep. 11, 2008

Related U.S. Application Data
(60) Provisional application No. 60/971,510, filed on Sep. 11, 2007.

(51) Int. Cl. G09G 5/02

(52) U.S. Cl. 345/591; 345/589

(57) ABSTRACT

Various aspects can be implemented for two dimensional representation of a color space. In general, one aspect can be a method for representing a color space, the method includes obtaining first, second, and third primary colors for the color space. The method also includes providing a first virtual triangle, the first virtual triangle includes a base, a height, and an area defined by height*base/2. The method further includes assigning the first primary color as the height of the first virtual triangle. The method also includes assigning a sum of the second and third primary colors as the base of the first virtual triangle, whereby the intensity of the first primary color can be adjusted by modifying the area of the first virtual triangle. Other implementations of this aspect include corresponding systems, apparatus, and computer program products.

### CROSS-REFERENCE TO RELATED APPLICATIONS

This application claims the benefit of priority from U.S. Provisional Patent Application No. 60/971,510, entitled “Two Dimensional Representation Of Color Spaces”, filed Sep. 11, 2007, which is incorporated by reference in its entirety.

### TECHNICAL FIELD

This disclosure generally relates to two dimensional representation of color spaces, using, for example, three virtual triangles to represent the primary colors (Red, Green, and Blue) of an RGB color space.

### BACKGROUND

Color can be completely specified by just three parameters. Their meanings depend on the particular color model or color space used. A number of color models have been developed that attempt to represent a gamut of colors, based on a set of primary colors, in a three-dimensional space. Each point in that space depicts a particular composite color made up of the primary colors. One traditional model is the RGB (Red, Green, Blue) color model. The RGB color model is an additive model in which red, green, and blue primary colors are combined in various ways to create other composite colors.

The RGB color model has each dimension of the cube representing a primary color and is mapped to a cube with Cartesian coordinates (R, G, B). Similarly, each point within the cube identified by a triplet (R, G, B) represents a particular composite color where the individual components R, G, or B shows the contribution of each primary color towards the given composite color. The diagonal of the cube (where the three RGB components are equal) represents the grayscale with black being 0% of the length of the diagonal and white being 100%.

### SUMMARY

This specification describes various aspects relating to two dimensional representation of color spaces, using, for example, three virtual triangles to represent the primary colors (Red, Green, and Blue) of an RGB color space. Two dimensional representation of color spaces can be used to improve the definition (color depth, or intensity) of digital images without changing the resolution. The definition of a color pixel in a bitmap image can be defined by the three primary color values red, green, blue. Additionally, these RGB color values can be represented by two dimensional objects using, for example, three virtual triangles to represent the primary colors, instead of the three dimensional representations using cube, tetrahedron, cones, and the like.

Moreover, the primary colors (RGB) can be used to form a virtual triangle, where the virtual triangle can have the characteristics of, e.g., height=one of the primary colors (R, G, or B), and base=sum of the other two primary colors. Thus, the quantity of light saturation present in every single color, or the intensity of color, in the traditional RGB (additive color space) color space can be represented using two dimensional objects without using the grey scale concept as in the RGB color cube (i.e., tonal relationship alone).

As an example of the virtual triangle representation of the RGB primary colors, the first virtual triangle can be characterized by Height=Red (i.e., the color value of Red color component), and Base=(Green+Blue) (i.e., sum of the color values of both Green and Blue color components). The second virtual triangle can be characterized by Height=Green (i.e., the color value of Green color component), and Base=(Red+Blue) (i.e., sum of the color values of both Red and Blue color components). Furthermore, the third virtual triangle can be characterized by Height=Blue (i.e., the color value of Blue color component), and Base=(Green+Red) (i.e., sum of the color values of both Green and Red color components).

Once the virtual triangles have been defined, the areas of these virtual triangles can be calculated. For example, the area of a triangle is defined as Area=Height*Base/2. Therefore, for the first virtual triangle (T1), Area_{T1=Red}_{T1}*(Green_{T1}+Blue_{T1})/2 because Height=Red_{T1}. Additionally, a new relationship between the three primary colors can be obtained based on the first virtual triangle. For instance, Red_{T1}=(2*Area_{T1})/(Green_{T1}+Blue_{T1}); Green_{T1}=((2*Area_{T1})/Red_{T1})−Blue_{T1}; and Blue_{T1}=((2*Area_{T1})/Red_{T1})−Green_{T1}.

Similarly, for the second virtual triangle (T2), a second area, Area_{T2}, can be obtained and a new relationship between the three primary colors can be obtained based on the second virtual triangle. For example, Area_{T2}=Green_{T2}*(Red_{T2}+Blue_{T2})/2 because Height=Green_{T2}; and Green_{T2}=(2*Area_{T2})/(Red_{T2}+Blue_{T2}). Additionally, for the third virtual triangle (T3), a third area, Area_{T3}, can be obtained and a new relationship between the three primary colors can be obtained based on the second virtual triangle. For example, Area_{T3}=Blue_{T3}*(Red_{T3}+Green_{T3})/2 because Height=Blue_{T3}; and Blue_{T3}=(2*Area_{T3})/(Red_{T3}+Green_{T3}).

In this manner, 9 different color values (3 Red color values: Red_{T1}, Red_{T2}, Red_{T3}; 3 Green color values: Green_{T1}, Green_{T2}, Green_{T3}; and 3 Blue color values: Blue_{T1}, Blue_{T2}, Blue_{T3}) can be obtained based on the three virtual triangles. Thus, there can be 4 different color values for each of the Red, Green, and Blue color components (e.g., the original Red plus the 3 new Red color values). An arithmetic mean value of the color values can be obtained; for example, Red_{new}=(Red+Red_{T1}+Red_{T2}+Red_{T3})/4. Additionally, a probabilistic quadratic mean value can be used to define the new color value; for example, Red_{new}=Sqrt(Red*Sqrt(Sqrt(Red_{T1}*Red_{T2})*Sqrt(Red_{T2}*Red_{T3}))). Furthermore, the new color value can include the color values from the virtual triangle, e.g., Red_{new}=Sqrt(Red_{T1}*Sqrt(Red_{T2}*Red_{T3})).

In this manner, by changing the area of these three virtual triangles, the intensity (saturation) of color (or the amount of light inside the color) associated with the height of each virtual triangle diffused in the digital image can be adjusted. Additionally, when the area of the virtual triangle is decreased, it is the height of the triangle that is directly affected and the intensity of the primary color associated with the height of the virtual triangle is reduced. Thus, the virtual triangular representation of color allows for a progressive and natural tweaking of the intensity of individual colors inside a digital image.

In contrast to the RGB color cube, where the maximum color value of a primary color is limited to 255 for an 8-bit color resolution, the two dimensional color representation using virtual triangles allows the intensity of individual primary colors (which is equivalent to the Height of the virtual triangle) to be increased to a much higher value than the 255 limit. On the other hand, similar to the Dark Method compression algorithm (where color values are compacted), the virtual triangles can be reduced in their areas to reduce the intensity of a specific primary color. In some implementations, the virtual triangular representation can offer more softness and continuity in reducing both intensity of the primary colors and their color values.

As noted above, the two dimensional color representation using virtual triangles can also be used to filter the primary colors. For example, by modifying the value of the area of the virtual triangle a change in the value of Red alone (in the example where Height of the triangle=Red) is changed, without changing the value of the other two colors (Blue or Green). Additionally, if the area is increased, the intensity of Red would be increased; on the other hand, if the area is reduced, the intensity of Red would decrease. In other words, the value of Red gets transferred to its complementary color, Cyan. In this manner, the filtering of individual colors allows for a more brilliant color adjustment by modifying from the inside of the color, and not as an overlap of more Red or more Cyan on the image.

In general, one aspect can be a method for representing a color space, the method includes obtaining first, second, and third primary colors for the color space. The method also includes providing a first virtual triangle, the first virtual triangle includes a base, a height, and an area defined by height*base/2. The method further includes assigning the first primary color as the height of the first virtual triangle. The method also includes assigning a sum of the second and third primary colors as the base of the first virtual triangle, whereby the intensity of the first primary color can be adjusted by modifying the area of the first virtual triangle. Other implementations of this aspect include corresponding systems, apparatus, and computer program products.

Another general aspect can be a system that includes an input module configured to obtain a digital image represented by an RGB color space. The system also includes means for representing the RGB color space using three virtual triangles. The system further includes an image adjustor configured to perform image adjustment by modifying the areas of the three virtual triangles.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1 is an example of a virtual triangle used in the two dimensional representation of the RGB color space.

FIG. 2 is an example of how the area of the virtual triangle can be adjusted by adjusting the height, which corresponds to one of the primary colors.

FIG. 3 is an example of how the primary color axes represented by the virtual triangle can each be independently adjusted.

FIG. 4 is a flow chart illustrating the process of using virtual triangles to represent a color space with three primary colors.

FIG. 5 is a flow chart illustrating how the two dimensional representation can be implemented to enhance the dark method encoding algorithm.

FIG. 6A is comparison of two digital images one with the traditional color representation and the other with the two dimensional representation.

FIG. 6B is comparison of two digital images one with the two dimensional representation and the other with the two dimensional representation with an additional integrated light control.

FIG. 7 is a block diagram of a computing device and system used to implement the enhanced image compression using the new byte representation.

Like reference symbols in the various drawings indicate like elements.

### DETAILED DESCRIPTION

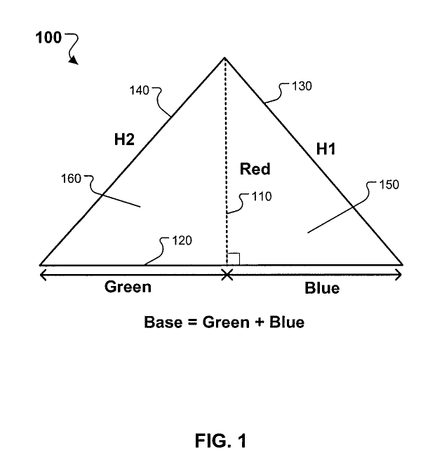

FIG. 1 is an example of a virtual triangle 100 used in the two dimensional representation of the RGB color space. Virtual triangle 100 illustrate how a new relationship between the primary colors can be obtained using a two dimensional representation. As shown in FIG. 1, virtual triangle 100 includes a height 110 and a base 120. Additionally, the height 110 makes a right angle with the base 120. The virtual triangle 100 also includes a side 130, which is labeled “H₁”, and a second side 140, which is labeled “H₂”. Furthermore, virtual triangle 100 can be used to represent the primary colors Red, Green, and Blue.

In the example shown in FIG. 1, the color value for Red has been assigned to be the height 110 of the virtual triangle 100. Additionally, the sum of the color values for Green and Blue has been assigned to be the base 120 of the virtual triangle 100. In this manner, virtual triangle 100 can be divided into a first right triangle 150, which is defined by the sides of Red and Blue, and a hypotenuse of H₁; and a second right triangle 160, which is defined by the sides of Red and Green, and a hypotenuse of H₂.

As noted above, in other implementations, the height 110 of the virtual triangle 100 can be on of the other primary colors (e.g., Blue or Green). For example, when the height 110 is Blue, then the base 120 is the sum of Green and Red. On the other hand, when the height 110 is Green, then the base 120 of the virtual triangle 100 is the sum of Blue and Red.

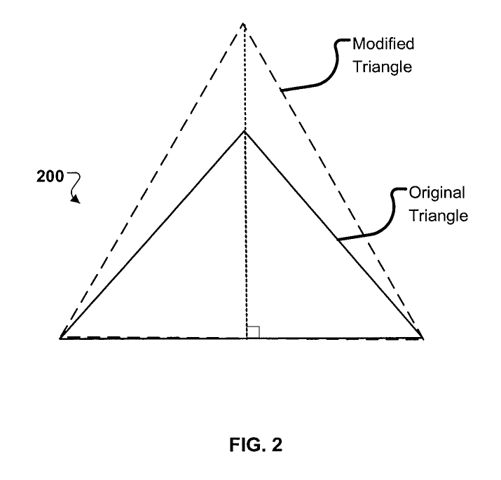

FIG. 2 is an example of how the area of the virtual triangle 200 can be adjusted by adjusting the height, which corresponds to one of the primary colors, e.g., Red, as shown in FIG. 1. As noted above, by representing the primary colors using virtual triangle 200, an individual primary color can be changed without changing the other two primary colors. For example, suppose that the height of the virtual triangle 200 has been assigned to be the color axis for Red. If more red is desired in a digital image, one can simply increased the height of virtual triangle 200, thereby increasing the area, without substantially changing the base, which is associated with the other two primary colors Green and Blue. This can be different from the traditional RGB color model, where if one increases the color value of red, then the composite color is also affected.

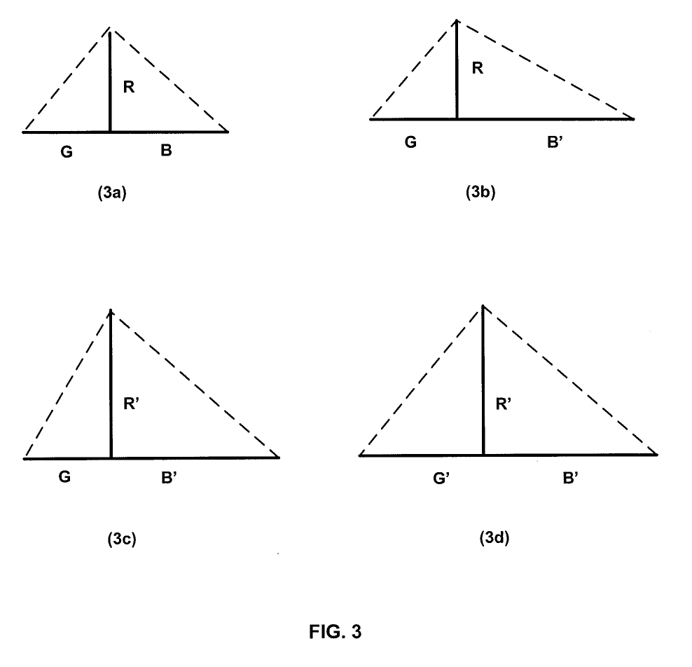

FIG. 3 is an example of how the primary color axes represented by the virtual triangle can each be independently adjusted. The advantages of using the virtual triangle to represent primary colors can be readily seen. For example, the virtual triangle can be adjusted by adjusting any one of the color axes, without affecting the value of the other color axes. FIG. 3b shows that the virtual triangle of FIG. 3a can be adjusted by adjusting the color axis B (Blue) to B′, without affecting the value of the other color axes (Green and Red axes). FIG. 3c shows that both the R and B axes can be adjusted without affecting the G axis. FIG. 3d shows that, if needed, all three color axes can be adjusted.

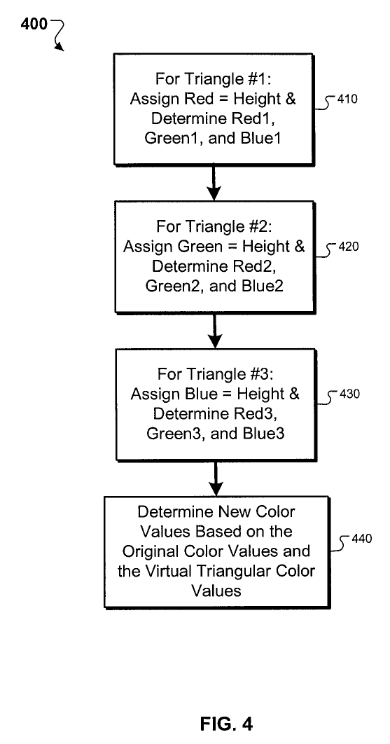

FIG. 4 is a flow chart illustrating the process 400 of using virtual triangles to represent a color space with three primary colors. For example, at step 410, for the first virtual triangle, process 400 assigns Height=Red (i.e., the color value of Red color component), and Base=(Green+Blue) (i.e., sum of the color values of both Green and Blue color components). Since the area of a triangle is defined as Area=Height*Base/2, the first virtual triangle (T1), Area_{T1}=Red_{T1}*(Green_{T1}+Blue_{T1})/2 because Height=Red_{T1}. Additionally, a new relationship between the three primary colors can be obtained based on the first virtual triangle. For instance, Red_{T1}=(2*Area_{T1})/(Green_{T1}+Blue_{T1}); Green_{T1}=((2*Area_{T1}/Red_{T1})−Blue_{T1}; and Blue_{T1}=((2*Area_{T1})/Red_{T1})−Green_{T1}.

Similarly, at step 420, the second virtual triangle can be characterized by Height=Green (i.e., the color value of Green color component), and Base=(Red+Blue) (i.e., sum of the color values of both Red and Blue color components). Additionally, for the second virtual triangle (T2), a second area, Area_{T2}, can be obtained and a new relationship between the three primary colors can be obtained based on the second virtual triangle. For example, Area_{T2}=Green_{T2}*(Red_{T2}+Blue_{T2})/2 because Height=Green_{T2}; and Green_{T2}=(2*Area_{T2})/(Red_{T2}+Blue_{T2}).

Furthermore, at step 430, the third virtual triangle can be characterized by Height=Blue (i.e., the color value of Blue color component), and Base=(Green+Red) (i.e., sum of the color values of both Green and Red color components). Additionally, for the third virtual triangle (T3), a third area, Area_{T3}, can be obtained and a new relationship between the three primary colors can be obtained based on the second virtual triangle. For example, Area_{T3}=Blue_{T3}*(Red_{T3}+Green_{T3})/2 because Height=Blue_{T3}; and Blue_{T3}=(2*Area_{T3})/(Red_{T3}+Green_{T3}).

In this manner, 9 different color values (3 Red color values: Red_{T1}, Red_{T2}, Red_{T3}; 3 Green color values: Green_{T1}, Green_{T2}, Green_{T3}; and 3 Blue color values: Blue_{T1}, Blue_{T2}, Blue_{T3}) can be obtained based on the three virtual triangles. Thus, there can be 4 different color values for each of the Red, Green, and Blue color components (e.g., the original Red plus the 3 new Red color values). At step 440, new color values can be determined based on the original color values and the color values obtained from the three virtual triangles. For example, arithmetic mean value of the color values can be obtained; for example, Red_{new}=(Red+Red_{T1}+Red_{T2}+Red_{T3})/4. Additionally, a probabilistic quadratic mean value can be used to define the new color value; for example, Red_{new}=Sqrt(Red*Sqrt(Sqrt(Red_{T1}*Red_{T2})*Sqrt(Red_{T2}*Red_{T3}))). Furthermore, the new color value can just include the color values from the virtual triangle , e.g., Red_{new}=Sqrt(Red_{T1}*Sqrt(Red_{T2}*Red_{T3})).

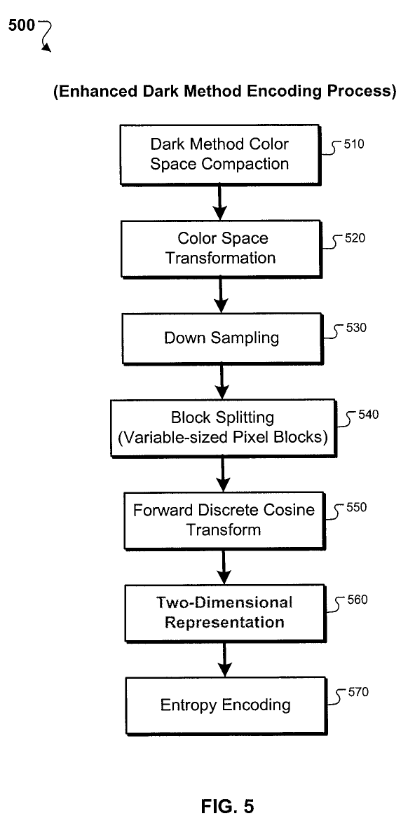

FIG. 5 is a flow chart illustrating a process 500 that uses the two dimensional representation to enhance the dark method encoding algorithm. Details of the dark method encoding process can be found in a co-pending application entitled “Image Enhancement and Compression,” which is a PCT application filed on Sep. 14, 2006. The dark method encoding algorithm is a lossy compression algorithm, and using the two dimensional representation digital image can be adjusted and enhanced even further without losing image quality. For example, the two dimensional representation can be incorporated after the forward discrete cosine transform step and prior to compression (e.g., lossless entropy encoding) in the dark method encoding process.

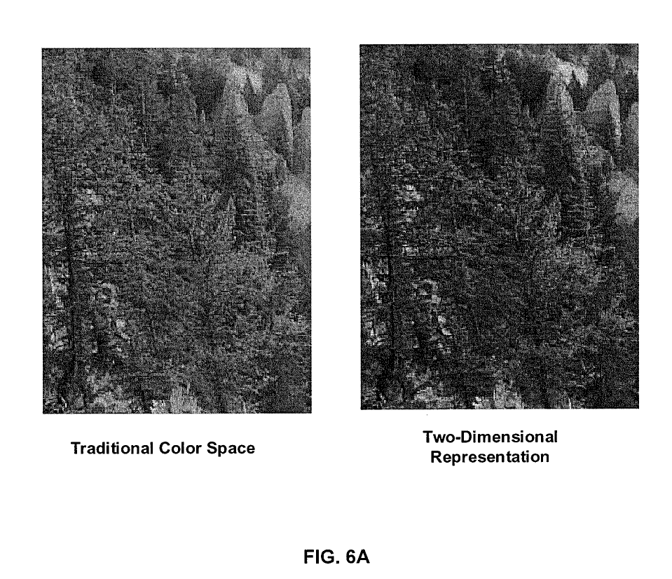

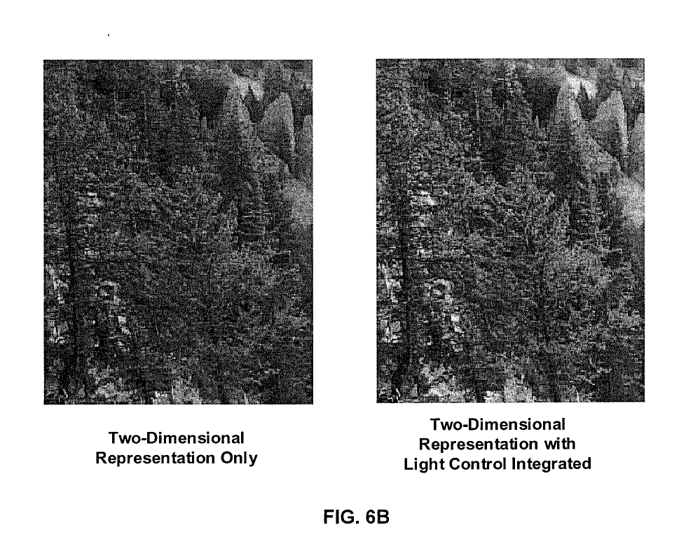

FIG. 6A is comparison of two digital images one with the traditional color representation and the other with the two dimensional representation. As shown in FIG. 6A, the digital image with the two dimensional representation can have an improved quality of vision with more color definition.

FIG. 6B is comparison of two digital images one with the two dimensional representation and the other with the two dimensional representation with an additional integrated light control. As shown in FIG. 6B, the two dimensional color representation can also be applied in combination with an integrated light control to further enhance the color definition.

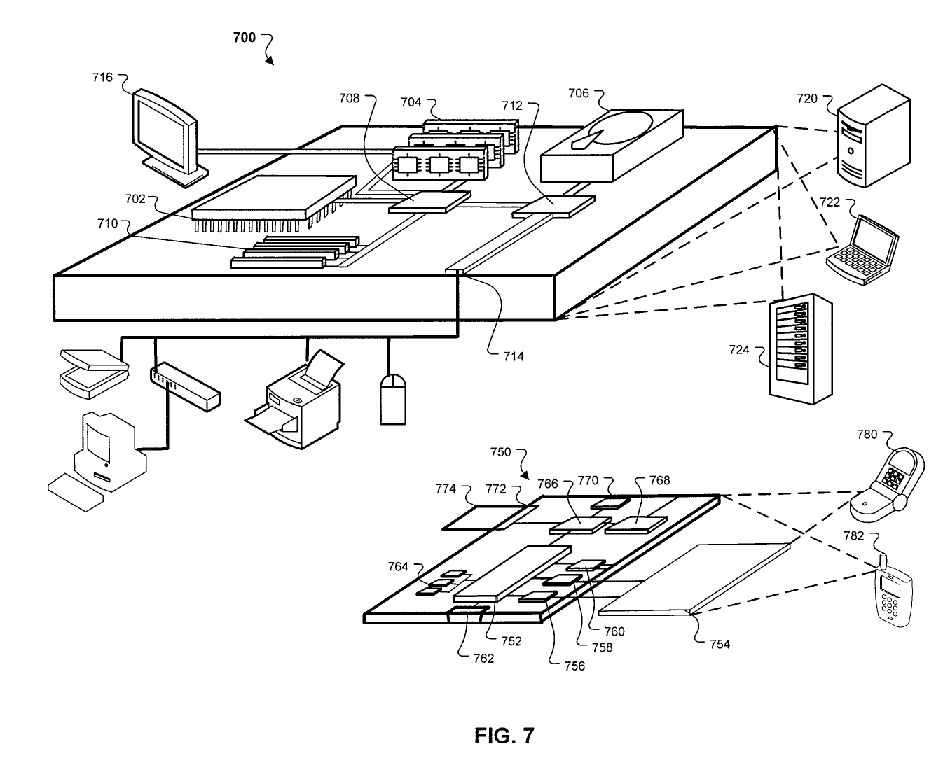

FIG. 7 is a block diagram of a computing device and system that can be used, e.g., to implement the two dimensional representation of color spaces. Computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708.

In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system). The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the described embodiments. Accordingly, other embodiments are within the scope of the following claims.

What is claimed is:

1. A computer-implemented method of representing a color space, the method comprising:
obtaining first, second, and third primary colors for the color space;
providing a first virtual triangle, the first virtual triangle includes a base, a height, and an area defined by height*base/2;
assigning the first primary color as the height of the first virtual triangle; and
assigning a sum of the second and third primary colors as the base of the first virtual triangle, whereby the intensity of the first primary color can be adjusted by modifying the area of the first virtual triangle.

2. The method of claim 1, further comprising:
providing a second virtual triangle, the second virtual triangle includes a base, a height, and an area defined by height*base/2
assigning the second primary color as the height of the second virtual triangle; and
assigning a sum of the first and third primary colors as the base of the second virtual triangle, whereby the intensity of the second primary color can be adjusted by modifying the area of the second virtual triangle.

3. The method of claim 2, further comprising:
providing a third virtual triangle, the third virtual triangle has a base, a height, and an area defined by height*base/2
assigning the third primary color as the height of the third virtual triangle; and
assigning a sum of the second and first primary colors as the base of the third virtual triangle, whereby the intensity of the third primary color can be adjusted by modifying the area of the third virtual triangle.

4. The method of claim 3, wherein an intensity of any of the first, second, or third primary colors can be modified without changing the intensity of the other two primary colors.

5. The method of claim 3, further comprising:
defining a relationship between the first, second, and third primary colors based on the first virtual triangle, such that the first primary color equals twice the area of the first virtual triangle divided by the sum of the second and the third primary colors.

6. The method of claim 5, further comprising:
defining a relationship between the first, second, and third primary colors based on the second virtual triangle, such that the second primary color equals twice the area of the second virtual triangle divided by the sum of the first and the third primary colors.

7. The method of claim 6, further comprising:
defining a relationship between the first, second, and third primary colors based on the third virtual triangle, such that the third primary color equals twice the area of the third virtual triangle divided by the sum of the second and the first primary colors.

8. The method of claim 7, further comprising:
obtaining an original color value associated with the first primary color;
obtaining a first color value associated with the first primary color of the first virtual triangle;
obtaining a second color value associated with the first primary color of the second virtual triangle;
obtaining a third color value associated with the first primary color of the third virtual triangle; and
defining a new color value associated with the first primary color, such that the new color value is based on an arithmetic mean of the original color value, the first color value, the second color value, and the third color value.

9. The method of claim 7, further comprising:
obtaining an original color value associated with the second primary color;
obtaining a first color value associated with the second primary color of the first virtual triangle;
obtaining a second color value associated with the second primary color of the second virtual triangle;
obtaining a third color value associated with the second primary color of the third virtual triangle; and
defining a new color value associated with the second primary color, such that the new color value is based on an arithmetic mean of the original color value, the first color value, the second color value, and the third color value.

10. The method of claim 7, further comprising:
obtaining an original color value associated with the third primary color;
obtaining a first color value associated with the third primary color of the first virtual triangle;
obtaining a second color value associated with the third primary color of the second virtual triangle;
obtaining a third color value associated with the third primary color of the third virtual triangle; and
defining a new color value associated with the third primary color, such that the new color value is based on an arithmetic mean of the original color value, the first color value, the second color value, and the third color value.

11. The method of claim 1, wherein the color space is an RGB color space.

12. The method of claim 1, wherein the first primary color corresponds to red, and wherein the second primary color corresponds to green, and further wherein the third primary color corresponds to blue.

13. A computer program product, encoded on a computer-readable medium, operable for representing a color space, and to cause data processing apparatus to perform operations comprising:
obtaining first, second, and third primary colors for the color space;
providing a first virtual triangle, the first virtual triangle includes a base, a height, and an area defined by height*base/2;
assigning the first primary color as the height of the first virtual triangle; and
assigning a sum of the second and third primary colors as the base of the first virtual triangle, whereby the intensity of the first primary color can be adjusted by modifying the area of the first virtual triangle.

14. The computer program product of claim 13, to cause data processing apparatus to perform further operations comprising:
providing a second virtual triangle, the second virtual triangle includes a base, a height, and an area defined by height*base/2
assigning the second primary color as the height of the second virtual triangle; and
assigning a sum of the first and third primary colors as the base of the second virtual triangle, whereby the intensity of the second primary color can be adjusted by modifying the area of the second virtual triangle.

15. The computer program product of claim 14, to cause data processing apparatus to perform further operations comprising:
providing a third virtual triangle, the third virtual triangle has a base, a height, and an area defined by height*base/2
assigning the third primary color as the height of the third virtual triangle; and
assigning a sum of the second and first primary colors as the base of the third virtual triangle, whereby the intensity of the third primary color can be adjusted by modifying the area of the third virtual triangle.

16. The computer program product of claim 13, wherein an intensity of any of the first, second, or third primary colors can be modified without changing the intensity of the other two primary colors.

17. The computer program product of claim 15, to cause data processing apparatus to perform further operations comprising:
defining a relationship between the first, second, and third primary colors based on the first virtual triangle, such that the first primary color equals twice the area of the first virtual triangle divided by the sum of the second and the third primary colors.

18. The computer program product of claim 17, to cause data processing apparatus to perform further operations comprising:
defining a relationship between the first, second, and third primary colors based on the second virtual triangle, such that the second primary color equals twice the area of the second virtual triangle divided by the sum of the first and the third primary colors.

19. The computer program product of claim 18, to cause data processing apparatus to perform further operations comprising:
defining a relationship between the first, second, and third primary colors based on the third virtual triangle, such that the third primary color equals twice the area of the third virtual triangle divided by the sum of the second and the first primary colors.

20. The computer program product of claim 19, to cause data processing apparatus to perform further operations comprising:
obtaining an original color value associated with the first primary color;
obtaining a first color value associated with the first primary color of the first virtual triangle;
obtaining a second color value associated with the first primary color of the second virtual triangle;
obtaining a third color value associated with the first primary color of the third virtual triangle; and
defining a new color value associated with the first primary color, such that the new color value is based on an arithmetic mean of the original color value, the first color value, the second color value, and the third color value.

21. The computer program product of claim 20, to cause data processing apparatus to perform further operations comprising:
obtaining an original color value associated with the second primary color;
obtaining a first color value associated with the second primary color of the first virtual triangle;
obtaining a second color value associated with the second primary color of the second virtual triangle;
obtaining a third color value associated with the second primary color of the third virtual triangle; and
defining a new color value associated with the second primary color, such that the new color value is based on an arithmetic mean of the original color value, the first color value, the second color value, and the third color value.

22. The computer program product of claim 21, to cause data processing apparatus to perform further operations comprising:
obtaining an original color value associated with the third primary color;
obtaining a first color value associated with the third primary color of the first virtual triangle;
obtaining a second color value associated with the third primary color of the second virtual triangle;
obtaining a third color value associated with the third primary color of the third virtual triangle; and
defining a new color value associated with the third primary color, such that the new color value is based on an arithmetic mean of the original color value, the first color value, the second color value, and the third color value.

23. The computer program product of claim 13, wherein the color space is an RGB color space.

24. The computer program product of claim 13, wherein the first primary color corresponds to red, and wherein the second primary color corresponds to green, and further wherein the third primary color corresponds to blue.

25. A system comprising:
an input module configured to obtain a digital image represented by an RGB color space;
means for representing the RGB color space using three virtual triangles; and
an image adjustor configured to perform image adjustment by modifying the areas of the three virtual triangles.
